(19) United States
(12) Patent Application Publication
(10) Pub. No.: US 2019/0236538 A1
(43) Pub. Date: Aug. 1, 2019

(54) MOVING BODY, PACKAGE SORTING SUPPORT METHOD EXECUTED BY MOVING BODY, NON-TRANSITORY COMPUTER-READABLE STORAGE MEDIUM STORING PROGRAM, AND PACKAGE SORTING SUPPORT SYSTEM

(71) Applicant: Toyota Jidosha Kabushiki Kaisha, Toyota-shi Aichi-ken (JP)

(72) Inventors: Yusuke Kaneko, Nagoya-shi Aichi-ken (JP); Masato Endo, Nagakute-shi Aichi-ken (JP); Daiki Kaneichi, Nisshin-shi Aichi-ken (JP); Shinji Sassa, Ama-shi Aichi-ken (JP); Takahiro Shiga, Chiryu-shi Aichi-ken (JP)

(73) Assignee: Toyota Jidosha Kabushiki Kaisha, Toyota-shi Aichi-ken (JP)

(21) Appl. No.: 16/255,047

(22) Filed: Jan. 23, 2019

(30) Foreign Application Priority Data
Jan. 31, 2018 (JP) 2018-015009

(51) Int. Cl. G06Q 10/08; G05D 1/00; B60P 3/00; H04W 4/40; H04W 4/029

(52) U.S. Cl. CPC G06Q 10/0833; G06Q 10/0832; H04W 4/029; B60P 3/007; H04W 4/40; G05D 1/0088

(57) ABSTRACT

A moving body, a package sorting support method, a non-transitory storage medium storing a program, and a package sorting support system are disclosed. The moving body includes a receiving unit, a delivery information acquisition unit, and a loading control unit. The receiving unit is configured to receive a request to pick up the pickup package from a user together with identification information of the pickup package. The delivery information acquisition unit is configured to acquire information of a delivery destination of the pickup package associated with the identification information of the pickup package. The loading control unit is configured to control loading of the pickup package such that the pickup package is loaded at a loading place in the moving body corresponding to the delivery destination of the pickup package.

### CROSS-REFERENCE TO RELATED APPLICATIONS

This application claims priority to Japanese Patent Application No. 2018-015009 filed on Jan. 31, 2018, which is incorporated herein by reference in its entirety including the specification, drawings and abstract.

### BACKGROUND

### 1. Technical Field

The disclosure relates to a moving body, a package sorting support method executed by a moving body, a non-transitory storage medium storing a program, and a package sorting support system.

### 2. Description of Related Art

In the related art, various package delivery systems have been proposed in order to improve the efficiency of package delivery. For example, with regard to receiving a package by a recipient, a technique has been proposed in which a moving body, in which a package is loaded, moves to a place of a delivery box unit at a delivery destination by autonomous driving and delivers the package (for example, Japanese Patent No. 6164599 (JP 6164599 B)).

### SUMMARY

In the technique described in JP 6164599 B, re-delivery work of packages is reduced by using a delivery box. In addition, manual work of transporting packages from a delivery vehicle loaded with the packages to delivery boxes is reduced. However, package delivery work includes various processes, such as package pickup, package sorting, transportation of packages to delivery destinations, and delivery to recipients (delivery of packages). For example, a person in charge who delivers packages to recipients sometimes needs time and effort to find out where a package to be delivered is disposed among the packages loaded in the delivery vehicle. Thus, for the processes during the package delivery work, proposals for improving the processing efficiency have not been sufficiently made.

The disclosure provides a technology that is capable of improving the efficiency of the package delivery work.

In the aspects of the disclosure, a configuration is adapted, in which information of the delivery destination of each pickup package, for which a pickup request has been received from the user, is acquired and loading of the pickup package is controlled so that the pickup package is loaded at a loading place in a moving body corresponding to the delivery destination.

A first aspect of the disclosure provides a moving body including: a receiving unit configured to receive a request to pick up a pickup package from a user together with identification information of the pickup package; a delivery information acquisition unit configured to acquire information of a delivery destination of the pickup package associated with the identification information of the pickup package; and a loading control unit configured to control loading of the pickup package such that the pickup package is loaded at a loading place in the moving body corresponding to the delivery destination of the pickup package.

The pickup package picked up from the user is not limited to a package for which the user makes a request for pickup from the home or the like, and may include a package that is carried to a pickup station, a delivery center, or the like and loaded in the moving body by the user. The identification information of the pickup package is information managed by a delivery company in order to specify each package. For example, the identification information of the pickup package is a slip number. The pickup request includes pickup location information for specifying a place where the pickup package is to be picked up. The number of pickup packages for which a pickup request has been made is not limited to one, and may be plural. The delivery destination of the pickup package may not include a detailed address such as a street address, and may be, for example, a predetermined area designated by a zip code or a municipality. The loading place in the moving body corresponding to the delivery destination of the pickup package may be, for example, a region (section) obtained by dividing the pickup package storage space in the moving body according to the delivery destination of each pickup package.

The moving body according to the first aspect of the disclosure enables controlling a pickup package to be loaded so as to be sorted according to the delivery destination of the pickup package in a case where the pickup package is loaded into the moving body. Therefore, since it becomes easy to find a package to be delivered, among the packages loaded in the moving body, at the time of delivering the pickup package to the recipient, it is possible to improve the efficiency of the package delivery work.

The moving body according to the first aspect may include a display unit provided on a wall surface of the moving body. The loading control unit may be configured to display, on the display unit, information indicating the loading place for each delivery destination in the moving body. The wall surface is not limited to the outer wall surfaces at the front, rear, right, and left of the moving body, and may include the inner wall and the ceiling in the moving body. The information indicating the loading place for each delivery destination is, for example, a sketch in the moving body partitioned for each delivery destination. On the inner wall surface facing the section in the moving body partitioned for each delivery destination, a delivery destination corresponding to each section may be displayed. The user can dispose packages to be loaded in the moving body so as to be sorted for each delivery destination with reference to the information displayed on the display unit.

The moving body according to the first aspect may include a movable body for loading configured to load the pickup package into the moving body. The loading control unit may be configured to cause the movable body for loading to dispose the pickup package at the loading place corresponding to the delivery destination of the pickup package. The moving body for loading is, for example, a robot or a small moving body that can move between the package pickup location and the moving body or within the moving body according to an instruction from the moving body. In a case where the moving body for loading moves to the pickup location where the pickup package is to be picked up and loads the pickup package, the moving body for loading transports the loaded pickup package into the moving body. In the moving body, the moving body for loading disposes the pickup package at the loading place in the moving body corresponding to the delivery destination of the pickup package. The moving body according to the aspect of the disclosure enables collecting a pickup package, transporting the pickup package into the moving body, and disposing the pickup package at the loading place corresponding to the delivery destination without manual operation. Therefore, it is possible to reduce manual work, such as collection of pickup packages and sorting of packages.

A second aspect of the disclosure provides a package sorting support method executed by a moving body. The package sorting support method includes:

receiving a request to pick up a pickup package from a user together with identification information of the pickup package; acquiring information of a delivery destination of the pickup package associated with the identification information of the pickup package; and controlling loading of the pickup package such that the pickup package is loaded at a loading place in the moving body corresponding to the delivery destination of the pickup package.

A third aspect of the disclosure provides a non-transitory storage medium storing a program. The program is executable by a computer of a moving body usable to load and deliver a pickup package picked up from a user. The program causes, when the program is executed by the computer, the computer to execute operations including: receiving a request to pick up the pickup package from the user together with identification information of the pickup package; acquiring information of a delivery destination of the pickup package associated with the identification information of the pickup package; and controlling loading of the pickup package such that the pickup package is loaded at a loading place in the moving body corresponding to the delivery destination of the pickup package.

A fourth aspect of the disclosure provides a package sorting support system including: a moving body; and a management apparatus of the moving body. The management apparatus includes a notification unit configured to acquire delivery information including identification information of a pickup package and information of a delivery destination, and notify the moving body of a request to pick up the pickup package, which is received from a user, together with the identification information of the pickup package. The moving body includes a receiving unit configured to receive the request to pick up the pickup package from the user, which is sent through the management apparatus, together with the identification information of the pickup package, a delivery information acquisition unit configured to acquire information of the delivery destination of the pickup package associated with the identification information of the pickup package, and a loading control unit configured to control loading of the pickup package such that the pickup package is loaded at a loading place in the moving body corresponding to the delivery destination of the pickup package.

The package sorting support system according to the fourth aspect of the disclosure may be configured to include one or a plurality of processing apparatuses, such as computers. In a case where the package sorting support system is configured to include a plurality of processing apparatuses, the respective components of the package sorting support system are distributedly provided in the processing apparatuses, and the respective processing apparatuses cooperate with each other to realize processing as the package sorting support system. The package sorting support system according to the fourth aspect of the disclosure may be formed on the moving body or may be formed outside the moving body. The technical idea disclosed with respect to the above moving body can also be applied to the package sorting support method, the non-transitory storage medium storing a package sorting support program, and the package sorting support system described above to the extent that technical inconsistency does not occur.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic configuration diagram of a package sorting support system according to a first embodiment;

FIG. 2 is a block diagram showing the schematic configuration of each of a moving body, a moving body for loading, a management server, a delivery server, and a user terminal shown in FIG. 1;

FIG. 3 is a diagram showing the external appearance of a moving body;

FIG. 4 is a table illustrating the data structure of moving body management information stored in a management server;

FIG. 5 is a table illustrating the data structure of moving body section information stored in a management server;

FIG. 6 is a diagram illustrating association between a section in a moving body and a delivery area;

FIG. 7 is a table illustrating the data structure of vehicle allocation information stored in a management server;

FIG. 8 is a table illustrating the data structure of delivery information stored in a delivery server;

FIG. 9 is a sequence diagram showing an operation example of the package sorting support system according to the first embodiment;

FIG. 10 is a flowchart showing a processing example of a controller of a management server in the operation example of FIG. 9;

FIG. 11 is a flowchart showing a processing example of a controller of a delivery server in the operation example of FIG. 9;

FIG. 12 is a flowchart showing a processing example of a controller of a user terminal in the operation example of FIG. 9;

FIG. 13 is a flowchart showing a processing example of a controller of a moving body in the operation example of FIG. 9;

FIG. 14 is a display example of a display for supporting sorting of packages; and

FIG. 15 is a flowchart showing a processing example of a controller of a moving body for loading in a second embodiment.

### DETAILED DESCRIPTION OF EMBODIMENTS

Hereinafter, a specific embodiment of the disclosure will be described with reference to the diagrams. Configurations described in the present embodiment are not intended to limit the technical scope of the disclosure only thereto unless otherwise specified.

### First Embodiment

Package Sorting Support System

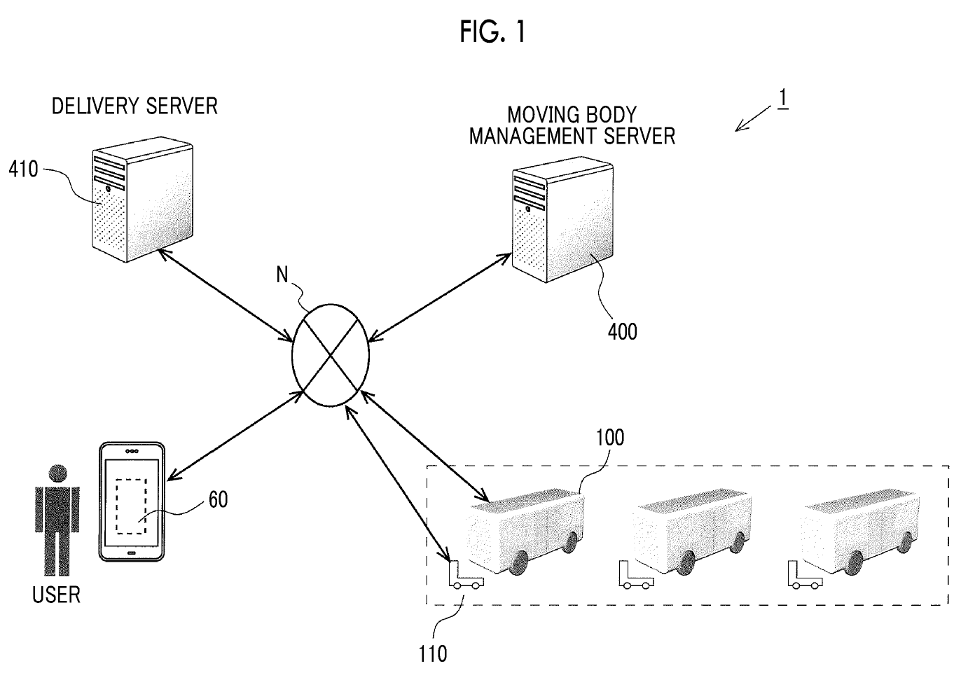

FIG. 1 is a schematic configuration diagram of a package sorting support system according to a first embodiment. In FIG. 1, the package sorting support system includes a moving body management server 400 (hereinafter, referred to as, a “management server 400”), a delivery server 410, a moving body 100, and a user terminal 60 that are communicably connected to a network N. The number of moving bodies 100 is not limited to one, but a plurality of moving bodies 100 may be included. The moving body 100 may have a moving body for loading 110. The management server 400 is an example of a “moving body management apparatus”.

As the network N, for example, a wide area network (WAN) that is a public communication network, such as the Internet, or other communication networks can be adopted. The network N may include a cellular network, such as long term evolution (LTE), and a wireless network, such as a wireless local area network (LAN: including wireless fidelity (Wi-Fi) (registered trademark)).

The delivery server 410 is managed by a package delivery company (hereinafter, referred to as a “delivery company”) that receives consignment from a customer of package pickup or delivery and receives a package at a pickup location designated by the customer or delivers the package to the delivery destination designated by the customer. The delivery server 410 manages information regarding the consigned package. The information regarding the package includes, for example, the contents of the package, pickup location (address, latitude, and longitude information of the location where the pickup package is to be picked up), the telephone number of the customer, pickup designated time, delivery destination (address, telephone number, and the like of the package receiving location), and delivery designated time.

The management server 400 is managed by a moving body manager who manages operating of the moving body 100 that supports the package pickup and delivery work. The management server 400 manages information regarding the moving body 100. The information regarding the moving body 100 includes, for example, information indicating the current location of the moving body 100 and information indicating an operating schedule. In response to a request from the delivery server 410, the user terminal 60, or the like, the management server 400 can provide the information regarding the moving body 100 to the requester. In addition, the management server 400 gives an instruction to the moving body 100 to perform control to move the moving body 100 to a predetermined location according to the operating schedule.

The moving body 100 has a package storage or loading space (hereinafter, referred to as a “loading place”). The moving body 100 stores packages picked up from users and packages entrusted to the delivery company by users, and delivers the packages to users of the delivery destinations.

In a case where a package pickup request is received, the moving body 100 moves to the pickup location designated in the pickup request and stops. The user who has made a request for pickup of a package loads the package in the package storage space of the moving body 100 that is stopped. In a case where loading of the package is completed, the moving body 100 starts moving to the next pickup location or the package delivery destination by an instruction from the management server 400.

In a case where the user loads the package in the storage space, the moving body 100 performs control so that the stored package is loaded so as to be sorted for each predetermined area including the delivery address. The predetermined area may be an administrative district or a geographical range appropriately determined by the delivery company. The area partitioning method can be appropriately selected. The size of the area is determined based on the number of packages delivered in the area and the like. However, the size of the area can also be set according to criteria other than the above. The moving body 100 acquires, from the management server 400, information of the delivery destination of the stored package and the package loading place for each area in the moving body 100.

For the package sorting control of the moving body 100, various methods are exemplified. For example, the moving body 100 presents a package loading place for each area in the moving body 100 to the user who loads the package. By disposing the package at the presented loading place by the user, the package stored in the moving body 100 is loaded so as to be sorted for each area of the delivery destination.

For example, the moving body 100 has the moving body for loading 110, such as a transporting robot or an autonomous traveling vehicle that performs autonomous traveling. Under the control of the moving body 100, the moving body for loading 110 receives the package to be picked up from the user, and transports the package to the moving body 100. Then, under the control of the moving body 100, the moving body for loading 110 disposes the package, which has been transported to the moving body 100, at a loading place of the area corresponding to the delivery destination of the package. In this manner, the moving body 100 can load packages picked up from users or packages entrusted to the delivery company by users so as to be sorted for each area of the delivery destination.

System Configuration

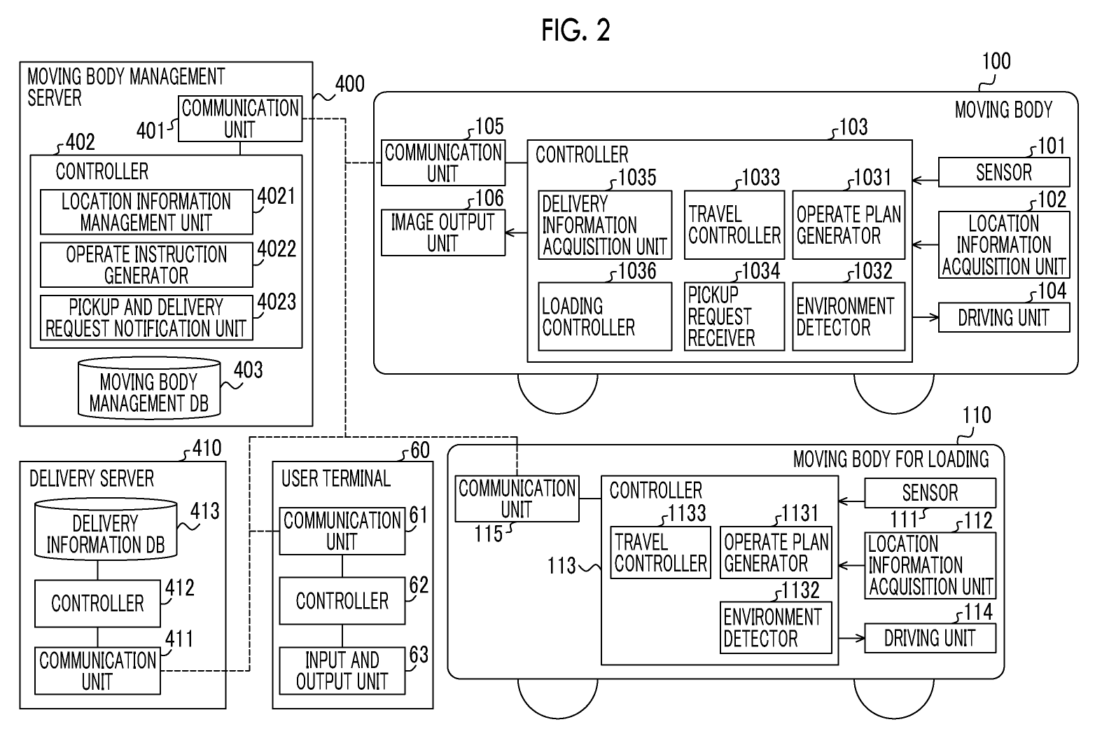

FIG. 2 is a configuration diagram schematically illustrating the configuration of each of the moving body 100, the moving body for loading 110, the management server 400, the delivery server 410, and the user terminal 60. Based on FIG. 2, the hardware configuration and functional configuration of the moving body 100, the moving body for loading 110, the management server 400, the delivery server 410, and the user terminal 60 will be described.

Moving Body

The moving body 100 is an autonomous traveling vehicle that performs autonomous traveling based on a given instruction. However, the moving body 100 may be a ship or an aircraft (airplane, helicopter, or the like) as long as the above-described pickup and delivery can be performed. In the present embodiment, the moving body 100 is a vehicle autonomously traveling on the road. The moving body 100 can move to the package pickup location designated by the user in response to the pickup request of the user. The package pickup location is designated by the user, but route up to the package pickup location is appropriately determined by the moving body 100, the management server 400, or the like.

The moving body 100 does not necessarily need to be unmanned, and autonomous traveling is not an indispensable requirement. For example, a person who provides package delivery service or package pickup service to the user or a security guard (to charge the moving body 100 and the like) may board the moving body 100. The moving body 100 does not necessarily always perform autonomous movement. For example, the movement may be performed by the control of a person. The control may be a control in a state in which a person boards the moving body 100, or may be a remote control using a remote controller or the like.

The moving body 100 travels according to the operate instruction acquired from the management server 400. Specifically, the moving body 100 generates a travel route based on an operate instruction acquired through wireless communication, and travels on the road in an appropriate method for autonomous traveling while sensing the surroundings of the moving body 100. The moving body 100 is configured to include a sensor 101, a location information acquisition unit 102, a controller 103, a driving unit 104, a communication unit 105, and an image output unit 106. A battery (secondary battery; not shown) is mounted on the moving body 100, and the moving body 100 operates with electric power supplied from the secondary battery.

The sensor 101 senses the surroundings of the moving body 100 in order to acquire information needed for autonomous traveling of the moving body 100. The sensor 101 includes, for example, a stereo camera, a laser scanner, a light detection and ranging (LIDAR), and a radar. The information acquired by the sensor 101 is transmitted to the controller 103, and is used by the controller 103 in order to recognize an obstacle and a traveling lane present around the moving body 100. In the present embodiment, the sensor 101 includes a visible light camera for monitoring. The location information acquisition unit 102 acquires the current location of the moving body 100. For example, the location information acquisition unit 102 is configured to include a global positioning system (GPS) receiver and the like. The information acquired by the location information acquisition unit 102 is also transmitted to the controller 103 and used in predetermined processing, such as calculation of a route for the moving body 100 to reach the destination using the current location of the moving body 100.

The controller 103 is a computer that performs processing relevant to autonomous traveling of the moving body 100 and processing relevant to sorting support of packages stored in the moving body 100 based on the information acquired from the sensor 101 or the location information acquisition unit 102. Although not shown, the controller 103 includes, for example, a central processing unit (CPU), a memory, and an auxiliary storage device (such as a hard disk). The CPU loads a program stored in the auxiliary storage device into the memory and executes the program, thereby realizing functions for performing the various kinds of processing described above. As specific examples of the various kinds of processing described above, the controller 103 operates as an operate plan generator 1031, an environment detector 1032, a travel controller 1033, a pickup request receiver 1034, a delivery information acquisition unit 1035, and a loading controller 1036.

The operate plan generator 1031, the environment detector 1032, and the travel controller 1033 are functional units that execute processes relevant to autonomous traveling of the moving body 100. The pickup request receiver 1034, the delivery information acquisition unit 1035, and the loading controller 1036 are functional units that execute processes relevant to sorting support of packages stored in the moving body 100. The pickup request receiver 1034, the delivery information acquisition unit 1035, and the loading controller 1036 are examples of a receiver, a delivery information acquisition unit, and a loading controller, respectively.

The operate plan generator 1031 acquires an operate instruction from the management server 400, and generates an operate plan of the moving body 100. The operate instruction includes information regarding a departure place and a destination given to the moving body 100. Therefore, the operate plan generator 1031 calculates a moving route of the moving body 100 based on the destination given from the management server 400 and the location of the moving body 100 acquired by the location information acquisition unit 102, and generates an operate plan for movement on the moving route. The destination given from the management server 400 is, for example, a package pickup location designated by the user. The operate plan includes data regarding the route, which is calculated as described above and along which the moving body 100 travels, and data specifying the processing to be performed by the moving body 100 in a part or the entirety of the route. Examples of data included in the operate plan include, for example, the following (1) and (2).
(1) <Data Indicating the Route Along which the Moving Body 100 Travels by a Set of Road Links>
   The route along which the moving body 100 travels may be automatically generated based on the given departure place and destination with reference to the stored map data, for example. The route along which the moving body 100 travels may be calculated by the processing of an external apparatus (for example, the management server 400) instead of the moving body 100. In this case, the management server 400 may acquire the location of the moving body 100 from the moving body 100, calculate a route to which the moving body 100 should travel, and include the calculated route data in the operate instruction or transmit the calculated route data to the moving body 100 separately.
(2) <Data Indicating Processing to be Performed by the Moving Body 100 at a Point on the Route>
   Processing performed by the moving body 100 include, for example, “unlocking/locking the cover of the package storage space”, “opening and closing the cover”, and “outputting an image (using a display to be described later)” under predetermined conditions. However, the disclosure is not limited thereto. The operate plan generated by the operate plan generator 1031 is transmitted to the travel controller 1033 to be described later.

Based on the data acquired by the sensor 101, the environment detector 1032 detects the surrounding environment of the moving body 100 used for autonomous traveling. Examples of a detection target include the number of lanes or lane positions, the number or locations of other moving bodies present around the moving body 100, the number or locations of obstacles (for example, pedestrians, bicycles, structures, and buildings) present around the moving body 100, the structure of roads, and road signs. However, the disclosure is not limited thereto. Any detection target may be included as long as the detection target is needed to perform autonomous traveling. For example, in a case where the sensor 101 is a stereo camera, an object around the moving body 100 is detected by performing image processing on image data captured by the stereo camera. The environment detector 1032 may not only detect an object around the moving body 100, but also track the detected object (continuously detect the detected object). For example, from the difference between the coordinates of an object detected one step before and the current coordinates of the object, the relative speed of the object can be calculated. The data regarding the surrounding environment of the moving body 100 (hereinafter, referred to as “environmental data”) detected by the environment detector 1032 is transmitted to the travel controller 1033 to be described later.

The travel controller 1033 generates a control instruction for controlling autonomous traveling of the moving body 100 based on the operate plan generated by the operate plan generator 1031, the environmental data generated by the environment detector 1032, and the location information of the moving body 100 acquired by the location information acquisition unit 102. For example, the travel controller 1033 generates a control instruction so that the moving body 100 travels along a predetermined route and no obstacle enters a predetermined safety region around the moving body 100. The generated control instruction is transmitted to the driving unit 104 to be described later. As a method of generating a control instruction for autonomously moving the moving body 100, a known method can be adopted.

The pickup request receiver 1034 receives a pickup request from the user. A specific example of a process in which the pickup request receiver 1034 receives a pickup request is shown. Firstly, the user inputs delivery information for making a request for pickup of a pickup package to the user terminal 60. The delivery information includes information of the delivery destination of a pickup package to be picked up, and may include information such as a contact address of a user who makes a request for pickup, a name of a recipient, and a contact address of a recipient. The delivery information input to the user terminal 60 is transmitted to the delivery server 410. The delivery server 410 stores the received delivery information in the auxiliary storage unit or the like provided in the delivery server 410 so as to be associated with the identification information of the pickup package. The identification information of the pickup package is an ID uniquely assigned to each package, such as a slip number managed by the delivery server 410. The delivery server 410 transmits a notification indicating that there is a request for pickup of a package to the management server 400 together with the identification information of the pickup package. The management server 400 determines the moving body 100, to which a pickup instruction is to be given, and transmits a pickup request together with the identification information of the pickup package. That is, the pickup request receiver 1034 of the moving body 100 to which a pickup instruction is given receives the pickup request input in the user terminal 60 through the delivery server 410 and the management server 400. The pickup request receiver 1034 receives the identification information of the pickup package, which is managed by the delivery server 410, through the management server 400. The pickup request receiver 1034 is an example of a receiver.

The delivery information acquisition unit 1035 acquires the information of the delivery destination of the pickup package based on the identification information of the pickup package received by the pickup request receiver 1034. Specifically, the delivery information acquisition unit 1035 acquires the information of the delivery destination of the pickup package, among the pieces of the delivery information associated with the identification information of the pickup package, through the management server 400. The information of the delivery destination is, for example, information of an area used to sort pickup packages, such as a zip code of a delivery destination and an address. Pickup packages loaded into the moving body can be disposed so as to be sorted for each zip code of a delivery destination or for each municipality, for example. The delivery information acquisition unit 1035 is an example of a delivery information acquisition unit.

The loading controller 1036 controls loading of each pickup package so that the pickup package is disposed at a corresponding loading place in the moving body 100 according to the information of the delivery destination of the pickup package acquired by the delivery information acquisition unit 1035. The association between the delivery destination and the loading place in the moving body 100 can be realized, for example, by dividing the storage space in the moving body 100 into a plurality of sections in advance and associating the delivery destination with each section. The delivery destination associated with each section is a predetermined area including the delivery destination of the pickup package (hereinafter, also referred to as a “delivery area”). For example, the delivery destination associated with each section can be an area specified by a zip code, a municipality, or the like.

The loading controller 1036 may associate each section with a delivery area at the time of loading a pickup package into the moving body 100. The loading controller 1036 may control the loading of the pickup package using preset information of the association between each section in the moving body 100 and the delivery area. Each section in the moving body 100 and the delivery area may be associated with each other by the management server 400. In this case, the loading controller 1036 can acquire information of the loading place, which is for associating each section in the moving body 100 and the delivery area with each other, from the management server 400 and perform control to dispose a pickup package in a section corresponding to the delivery area. The loading controller 1036 is an example of a loading controller.

The driving unit 104 makes the moving body 100 travel based on the control instruction generated by the travel controller 1033. The driving unit 104 is configured to include, for example, a motor, an inverter, a brake, and a steering mechanism for driving the wheels of the moving body 100, and drives the motor, the brake, and the like according to the control instruction to realize autonomous traveling of the moving body 100.

The communication unit 105 connects the moving body 100 to the network N. As the communication unit 105, a network interface card (NIC; not shown) or the like is applied. In the present embodiment, the communication unit 105 can communicate with another apparatus (for example, the management server 400) through the network N using a mobile communication service, such as 3rd Generation (3G) or LTE.

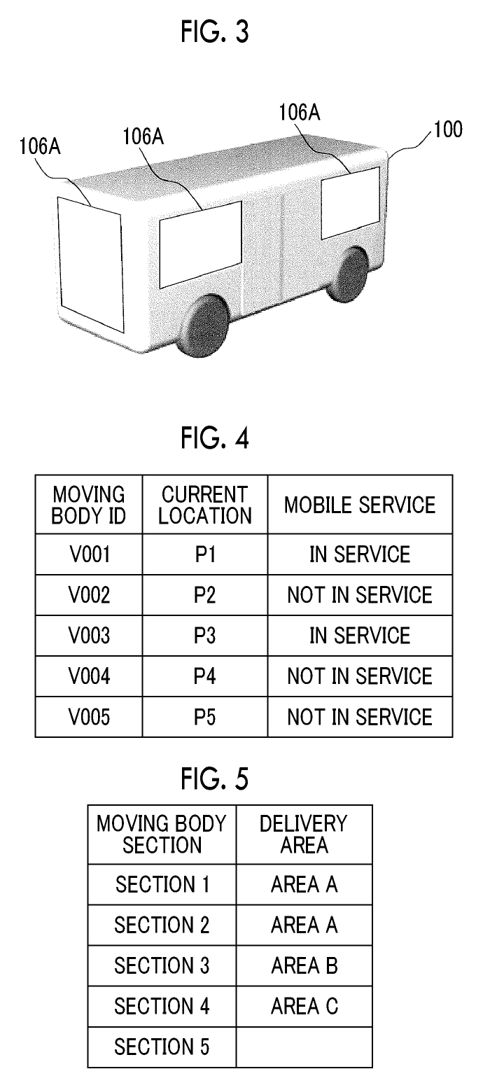

The image output unit 106 outputs an image to a display 106A provided in the vehicle body. FIG. 3 is a diagram illustrating the external appearance of the moving body 100. As shown in the diagram, in the present embodiment, the moving body 100 has a plurality of displays 106A on the outer wall of the vehicle body, so that it is possible to output desired images. The display 106A may be provided on a wall surface, a ceiling, or the like in the moving body without being limited to the outer wall. The display 106A may be a liquid crystal display, or may be formed by a light emitting diode (LED) matrix or the like. The image output unit 106 can generate or acquire an image based on the delivery information acquired from the management server 400 and output the image to the display 106A. The delivery information includes information of the delivery destination of a package to be picked up and a package loading place for each area including the delivery destination in the moving body 100. The display 106A is an example of a display unit.

Moving Body for Loading

Next, the moving body for loading 110 will be described. The moving body for loading 110 is an autonomous traveling vehicle that is provided in each moving body 100 and performs autonomous traveling based on a given instruction. The moving body for loading 110 transports a pickup package from the user into the moving body 100, and disposes the pickup package at a loading place corresponding to the delivery destination of the pickup package. The instruction given to the moving body for loading 110 includes identification information of the pickup package, information of the pickup location of the pickup package, information of the current location of the moving body 100 into which the pickup package is to be loaded. The moving body for loading 110 generates a travel route based on an instruction, autonomously travels while sensing the surroundings of the moving body for loading 110, and loads the pickup package from the user into the moving body 100. The moving body for loading 110 may receive the instruction from the moving body 100, or may receive the instruction from the management server 400.

The moving body for loading 110 is configured to include a sensor 111, a location information acquisition unit 112, a controller 113, a driving unit 114, and a communication unit 115. A battery (secondary battery; not shown) is mounted on the moving body for loading 110, and the moving body for loading 110 operates with electric power supplied from the secondary battery. Since the sensor 111, the location information acquisition unit 112, the driving unit 114, and the communication unit 115 of the moving body for loading 110 are the same as the sensor 101, the location information acquisition unit 102, the driving unit 104, and the communication unit 105 of the moving body 100, respectively, the description thereof will be omitted.

The controller 113 is a computer that performs processing relevant to autonomous traveling of the moving body for loading 110 based on the information acquired from the sensor 111 or the location information acquisition unit 112. Although not shown, the controller 113 includes, for example, a CPU, a memory, and an auxiliary storage device (such as a hard disk). The CPU loads a program stored in the auxiliary storage device into the memory and executes the program, thereby realizing functions for performing the various kinds of processing described above. As specific examples of the various kinds of processing described above, the controller 113 operates as an operate plan generator 1131, an environment detector 1132, and a travel controller 1133.

The operate plan generator 1131 acquires, from the moving body 100, an instruction to load a pickup package into the moving body 100, and generates an operate plan of the moving body 100. The operate plan generator 1131 may load the pickup package into the moving body 100 according to the instruction from the management server 400. The instruction includes information regarding the pickup location of the pickup package and the current location of the moving body 100 as a storage destination of the pickup package, which is given to the moving body for loading 110. Therefore, the operate plan generator 1131 calculates a moving route of the moving body for loading 110 based on the current location of the moving body 100 given from the management server 400 and the location of the vehicle of the moving body 100 (moving body for loading 110) acquired by the location information acquisition unit 112, and generates an operate plan for movement on the moving route. Since the environment detector 1132 and the travel controller 1133 are the same as the environment detector 1032 and the travel controller 1033 of the moving body 100, the description thereof will be omitted.

Management Server

Next, the management server 400 will be described. The management server 400 is an apparatus that manages autonomous traveling of the moving bodies 100 and transmits an operate instruction. For example, in a case where a package delivery request or a pickup request is received, the management server 400 acquires the delivery location or the pickup location (designated location) and then transmits an operate instruction to the moving body 100 traveling in the vicinity of the delivery location or the pickup location (designated location). The management server 400 is also an apparatus that provides information regarding the moving body 100 to a delivery company (delivery server 410).

The management server 400 has a general computer configuration. Specifically, the management server 400 includes a processor (not shown) such as a CPU or a digital signal processor (DSP), a memory (not shown) such as a random access memory (RAM) or a read only memory (ROM), and an auxiliary storage device (not shown) such as an erasable programmable ROM (EPROM), a hard disk drive (HDD), or a removable medium. The removable medium is, for example, a universal serial bus (USB) memory or a disk recording medium, such as a compact disc (CD) or a digital versatile disc (DVD). The auxiliary storage device stores an operating system (OS), various programs, various tables, and the like, and the processor loads the program stored in the auxiliary storage device to the work area of the memory and executes the program. By performing various processes or operations through the execution of the program, it is possible to realize a function matching a predetermined purpose.

The management server 400 has a communication unit 401. The communication unit 401 connects to another apparatus through the network N to perform communication between the management server 400 and the moving body 100 and the like. The communication unit 401 is, for example, the NIC or a wireless communication circuit for wireless communication. The NIC or the wireless communication circuit is connected to the network N.

The management server 400 further has a moving body management DB 403, which stores various kinds of information regarding the moving bodies 100 traveling autonomously, in the auxiliary storage device of the management server 400. The database (DB) is constructed by managing data stored in the auxiliary storage device using a program of a database management system (DBMS) executed by the processor. The moving body management DB 403 is, for example, a relational database.

Here, the configurations of moving body management information, moving body section information, and vehicle allocation information stored in the moving body management DB 403 will be described with reference to FIGS. 4, 5, and 7.

FIG. 4 is a table illustrating the data structure of moving body management information stored in the management server 400. A moving body management information table that stores the moving body management information has fields of a moving body ID, a current location, and a mobile service. The moving body ID field stores identification information for specifying a moving body managed by the management server 400. The current location field stores information for specifying a place where each moving body 100 is currently located. Specifically, the current location is information relevant to the latitude and longitude for specifying the current location of the moving body 100. The current location field corresponding to the moving body 100 in the moving body management DB 403 is updated each time the information of the current location acquired by the location information acquisition unit 102 in the moving body 100 is transmitted from the moving body 100 to the management server 400. The mobile service field stores information indicating whether or not the moving body 100 is currently providing a mobile service for users by autonomous traveling. For example, in a case where the moving body 100 is providing a mobile service, the mobile service field stores “in service”. In a case where the moving body 100 is not providing the mobile service, the mobile service field stores “not in service”. In a case where a package pickup request is received from the user through the delivery server 410, the management server 400 allocates the moving body 100 closest to the pickup location designated by the user among the moving bodies 100 not in service.

FIG. 5 is a table illustrating the data structure of moving body section information stored in the management server 400. A moving body section information table that stores moving body section information is a table used to associate a section in the moving body 100 and a delivery area with each other. One record of the moving body section information table is created for each section obtained by dividing the storage space in the moving body 100. The example of FIG. 5 shows an example in which the storage space in the moving body 100 is divided into five parts, but the number of sections after division is not limited to five, and may be determined according to the number of delivery areas of loaded pickup packages.

Each section and each delivery area may be associated with each other in advance. In a case where there is a request for information of a loading place from the moving body 100, the management server 400 may associate a section not associated with a delivery area, among the sections of the moving body 100, with a delivery area of a pickup package to be picked up.

The moving body section information table has fields of a moving body section and a delivery area. The moving body section field stores a plurality of sections obtained by dividing the storage space in the moving body 100. A specific region occupied by each section can be specified by, for example, a coordinate system having any corner of the floor as the origin. The delivery area field stores a predetermined area including the delivery address of a pickup package.

The information stored in the moving body section information table, that is, loading place information in which a section in the moving body 100 is associated with a delivery area, is transmitted from the management server 400 to the moving body 100 to which a pickup instruction has been given. The loading controller 1036 of the moving body 100 can dispose each pickup package at a loading place corresponding to the delivery destination based on the received loading place information. The loading place information may be stored in an auxiliary storage unit (not shown) provided in the moving body 100.

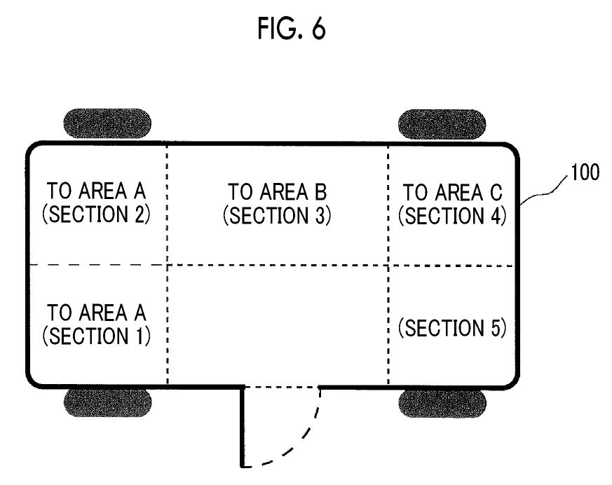

Here, an example of associating a section in the moving body 100 with a delivery area will be described with reference to FIG. 6. FIG. 6 shows an example of associating a section in the moving body 100 with a delivery area based on the example of the moving body section information table shown in FIG. 5. The storage space in the moving body 100 is divided into sections 1 to 5. The sections 1 to 4 are associated with a delivery area A, the delivery area A, a delivery area B, and a delivery area C, respectively, in the moving body section information table shown in FIG. 5. The section 5 is not associated with any delivery area. In a case where each section is associated with the delivery area as shown in FIG. 6, for example, a pickup package having a delivery address included in the delivery area A may be disposed in the storage space of the section 1 or the section 2.

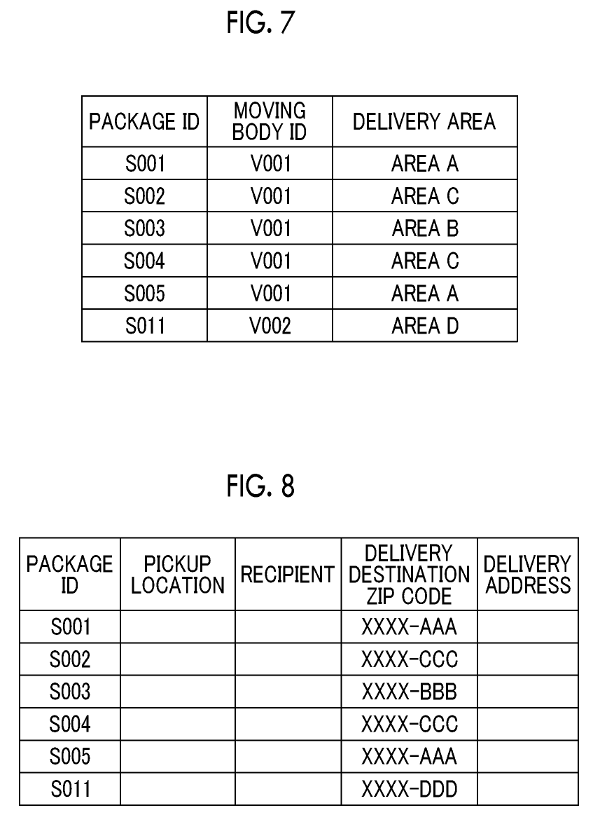

FIG. 7 is a diagram illustrating the data structure of vehicle allocation information stored in the management server. A vehicle allocation information table that stores the vehicle allocation information is used to determine the moving body 100, to which a pickup instruction is to be given, in a case where the management server 400 receives a pickup request. One record of the vehicle allocation information table is created in a case where the management server 400 determines the moving body 100, to which a pickup instruction is to be given, for one pickup package. The vehicle allocation information table has fields of a package ID, a moving body ID, and a delivery area.

The package ID field stores identification information of a pickup package for which a pickup request has been made. The management server 400 receives the identification information of the pickup package from the delivery server 410. The moving body ID field stores identification information of the moving body 100 to be instructed to pick up the pickup package. The moving body 100 to be instructed to pick up the pickup package is determined by the management server 400. For example, as described with reference to FIG. 4, the management server 400 can determine the moving body 100 closest to the pickup location designated by the user, among the moving bodies 100 not in service, as the moving body 100 to be instructed to pick up the pickup package. The delivery area field stores information of a predetermined area including the delivery address of a pickup package. Since the delivery area is associated with a section in the moving body 100, each pickup package is controlled so as to be disposed at a loading place (section) corresponding to the delivery area.

In the management server 400, a controller 402 as a functional unit is formed by execution of a program by the processor described above. The controller 402 performs the above-described processing relevant to autonomous traveling of the moving body 100, processing relevant to sorting support of packages stored in the moving body 100, and the like. Specifically, the controller 402 operates as a functional unit, such as a location information management unit 4021, an operate instruction generator 4022, and a pickup and delivery request notification unit 4023. Among these, the location information management unit 4021 and the operate instruction generator 4022 execute the processing relevant to autonomous traveling of the moving body 100. The pickup and delivery request notification unit 4023 executes the processing relevant to sorting support of packages stored in the moving body 100.

The location information management unit 4021 and the operate instruction generator 4022 will be described. The location information management unit 4021 receives and manages location information from the moving bodies 100 managed by the management server 400. Specifically, current location information is received from the moving bodies 100 at that point in time for each predetermined period, and is stored in the moving body management DB 403.

In a case where a pickup request is received, the operate instruction generator 4022 determines the moving body 100 to be used for pickup, and generates an operate instruction corresponding to the pickup location included in the pickup request. The operate instruction includes a pickup location as a destination, and may include information indicating a route to the destination. The pickup location may be a location designated by the user who makes a pickup request, or may be a delivery center of a delivery company that receives a package delivery request from the user.

The pickup and delivery request notification unit 4023 acquires delivery information including package identification information and delivery destination information from the delivery server 410. The pickup and delivery request notification unit 4023 notifies the moving body 100 of the package identification information included in the acquired delivery information and the package pickup request from the user. The pickup and delivery request notification unit 4023 is an example of a notification unit.

Delivery Server

Next, the delivery server 410 will be described. The delivery server 410 has a general computer configuration. Similarly to the management server 400, the delivery server 410 is a computer having a processor (not shown), such as a CPU or a DSP, and a storage device (including a RAM, a ROM, an EPROM, a hard disk drive, a removable medium, and the like), or a computer having a processor (not shown) such as a CPU or a DSP, a main storage unit (not shown) such as a RAM or a ROM, and an auxiliary storage unit (not shown) such as an EPROM, a hard disk drive, or a removable medium. The auxiliary storage unit stores an operating system, various programs, various tables, and the like. By loading the program stored in the auxiliary storage unit to the work area of the main storage unit and executing the program so that each constituent unit and the like are controlled through the execution of the program, it is possible to realize a function matching a predetermined purpose.

The delivery server 410 has a communication unit 411. Similarly to the communication unit 401 of the management server 400, the communication unit 411 connects to another apparatus (for example, the management server 400 or the user terminal 60) to perform communication between the delivery server 410 and another apparatus. The communication unit 411 is, for example, the NIC or a wireless communication circuit for wireless communication. The NIC or the wireless communication circuit is connected to the network N.

The delivery server 410 has a delivery information DB 413. The delivery information DB 413 is formed by storing delivery information regarding a pickup or delivery request received from the user in the above-described auxiliary storage unit. In the delivery information DB 413, identification information is assigned to each package to be picked up or delivered. The identification information of each package is associated with information of the delivery destination of the package. The delivery information DB 413 is constructed by managing data stored in the auxiliary storage unit using a program of a database management system executed by the processor. The delivery information DB 413 is, for example, a relational database.

Here, the configuration of delivery information stored in the delivery information DB 413 will be described with reference to FIG. 8. FIG. 8 is a table illustrating the data structure of delivery information stored in the delivery server. The delivery information table is a table used to receive a pickup request from the user. One record of the delivery information table is created for each pickup package that is requested to be picked up. The delivery information table has fields of a package ID, a pickup location, a recipient, a delivery destination zip code, and a delivery address.

The package ID field stores identification information of a pickup package for which a pickup request has been made. The identification information of a pickup package is, for example, a delivery slip number managed by the delivery company. The delivery slip number may be set by inputting the number described in the delivery slip, which is acquired in advance by the user, at the time of pickup request. The delivery slip number may be set by the delivery server 410 that receives a pickup request from the user.

The pickup location field stores a pickup location designated by the user. The pickup location may be designated by an address, or may be designated by location information based on the latitude and longitude of the user terminal 60 at the time of pickup request from the user. The management server 400 can allocate the moving body 100 closest to the pickup location based on the information of the pickup location received from the delivery server 410.

The recipient field stores a recipient of a pickup package. The delivery destination zip code field stores the zip code of the delivery destination of a pickup package. The delivery address field stores the address of the delivery destination of a pickup package. For example, in a case where information of a delivery destination zip code or a delivery address is received from the delivery server 410, the management server 400 can set the municipality of the zip code or the delivery address as a delivery area and associate the delivery area with a section in the moving body 100 in the moving body section information table shown in FIG. 5.

User Terminal

The user terminal 60 is used by the user who makes a request for pickup of a package. The user terminal 60 may be a mobile terminal including a smart device, such as a smartphone or a tablet, or may be a personal computer or a workstation, or may be an in-vehicle terminal. The user terminal 60 has a communication unit 61, a controller 62, and an input and output unit 63. As the communication unit 61 and the controller 62, devices of the same type as devices used to configure the communication unit 401 and the controller 402 of the management server 400 can be applied. The input and output unit 63 includes an input device (a button, a key, a pointing device, a touch panel, a microphone, and the like) and an output device (a display, a speaker, and the like).

The user inputs delivery information regarding a pickup package, for which a pickup request has been made, to the user terminal 60. The user terminal 60 notifies the delivery server 410 of a package pickup request together with the delivery information input by the user. The package pickup request is sent to the management server 400 through the delivery server 410.

Any one of the functional components of the management server 400 and the delivery server 410 or a part of the processing may be executed by another computer connected to the network N. The series of processes executed by the management server 400 and the delivery server 410 can be executed by hardware, but can also be executed by software. The same applies to the user terminal 60.

Operation Examples

Hereinafter, an operation example of a package sorting system that acquires information of the delivery destination of each pickup package, for which a pickup request has been received from the user, and controls loading of the pickup package so that the pickup package is loaded at a loading place in the moving body corresponding to the delivery destination will be described.

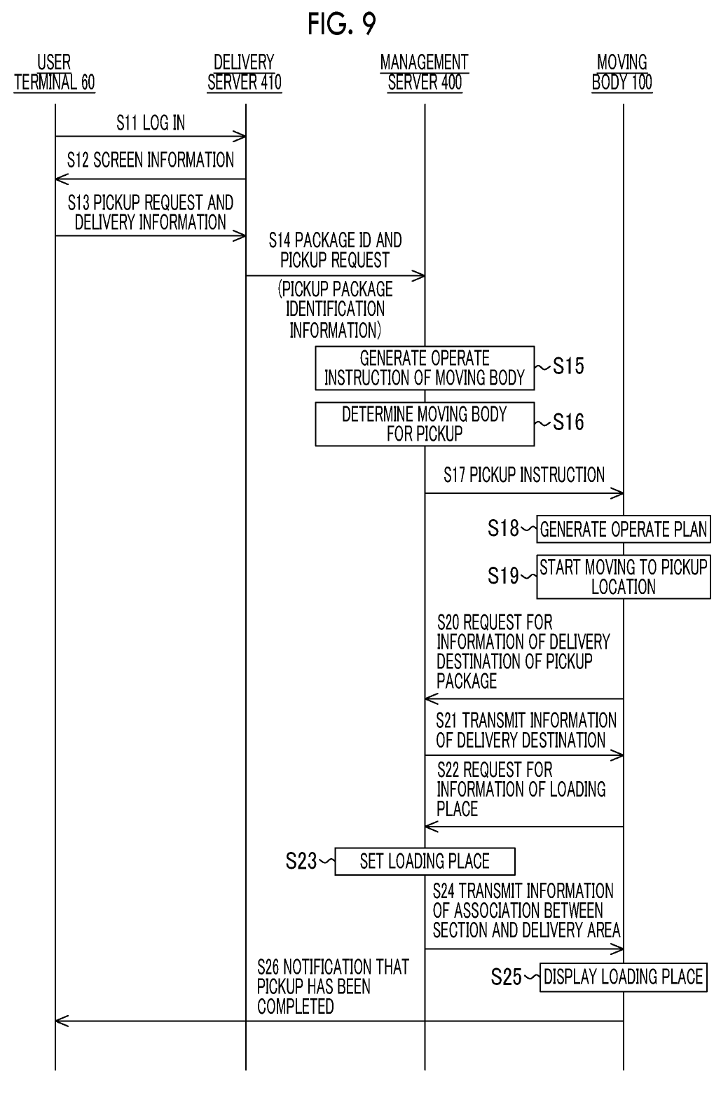

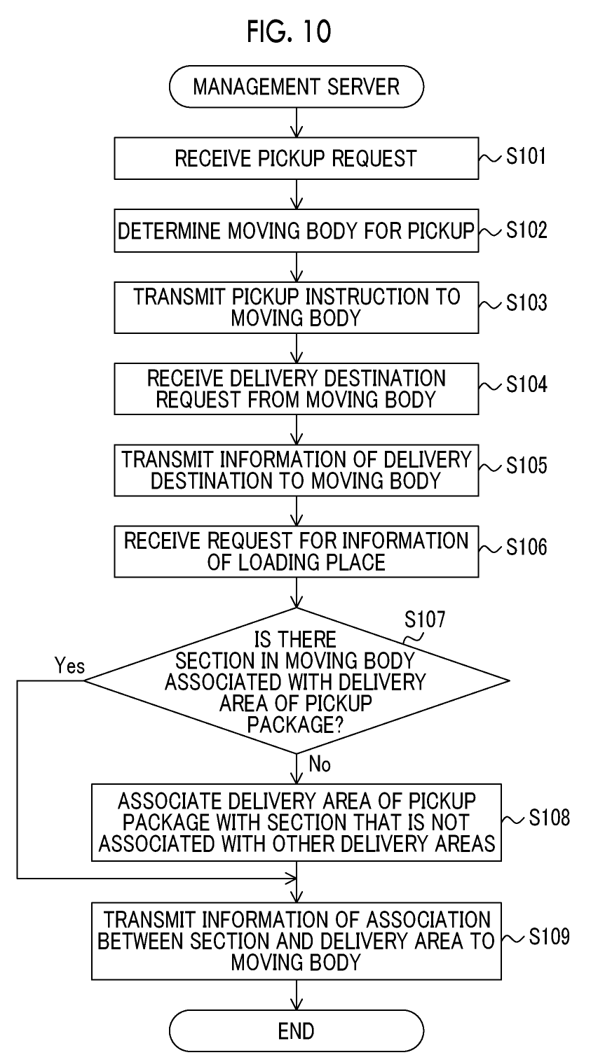

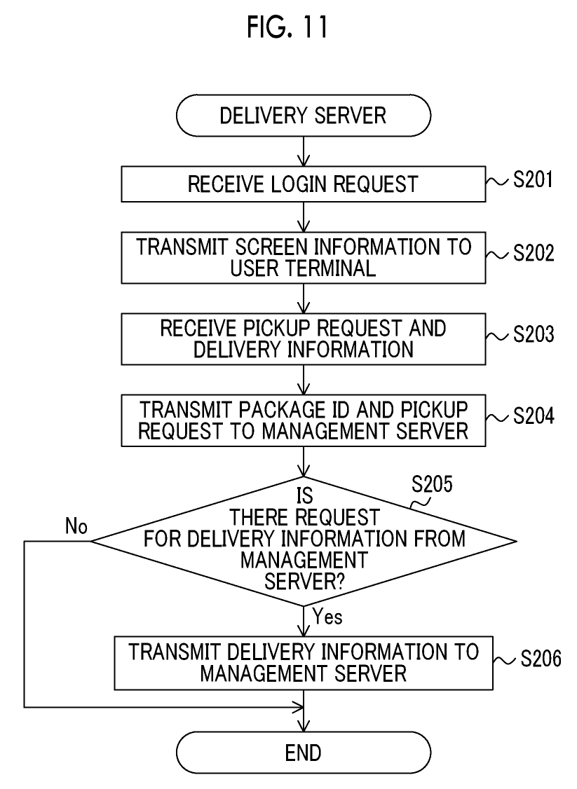

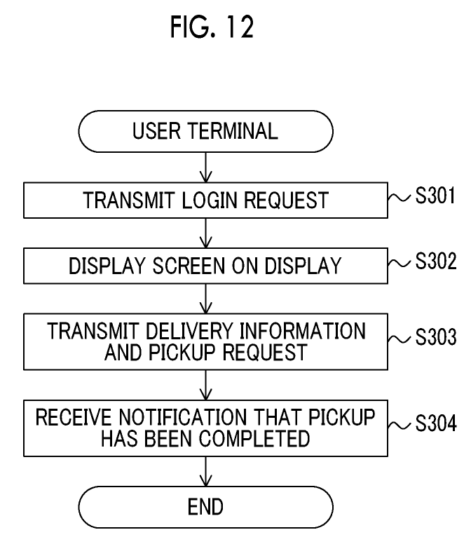

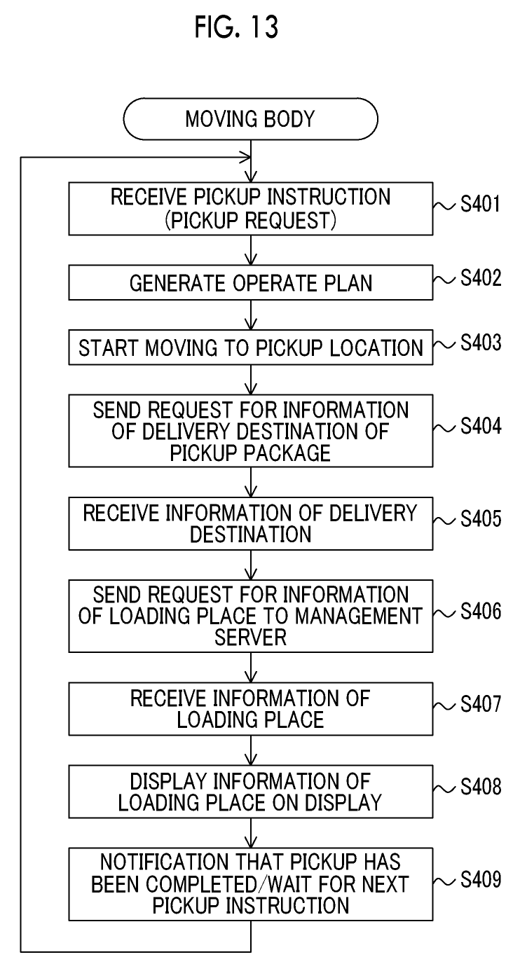

FIG. 9 is a sequence diagram showing an operation example of the package sorting support system according to the first embodiment. FIG. 10 is a flowchart showing a processing example of the controller 402 of the management server 400 in this operation example. FIG. 11 is a flowchart showing a processing example of the controller 412 of the delivery server 410 in this operation example. FIG. 12 is a flowchart showing a processing example of the controller 62 of the user terminal 60 in this operation example. FIG. 13 is a flowchart showing a processing example of the controller 103 of the moving body 100 in this operation example.

In FIG. 9, a user who desires pickup of a package operates the user terminal 60 to log in to a website operated by the delivery server 410 (S11 in FIG. 9 and S301 in FIG. 12). At this time, the login request is received by the delivery server 410 (S201 in FIG. 11), and the controller 412 of the delivery server 410 transmits screen information, which is for inputting delivery information regarding pickup and delivery of packages, to the user terminal 60 (S12 in FIG. 9 and S202 in FIG. 11).

The user terminal 60 displays a screen based on the screen information received from the delivery server 410 on a display (S302 in FIG. 12). The user makes a pickup request by inputting delivery information including the pickup location and the recipient of a pickup package, the zip code and the address of the delivery destination, and the like using the displayed screen. The pickup request is transmitted to the delivery server 410 together with the delivery information (S13 in FIG. 9 and S303 in FIG. 12).

In a case where the pickup request is received together with the delivery information (S203 in FIG. 11), the controller 412 of the delivery server 410 stores the received delivery information in the delivery information table shown in FIG. 8. In a case where identification information of the pickup package is included in the delivery information received from the user terminal 60, the identification information is stored in the package ID field of the delivery information table. On the other hand, in a case where the identification information of the pickup package is not included in the delivery information received from the user terminal 60, the delivery server 410 sets an ID unique to the pickup package, and stores the set ID in the package ID field.

The delivery server 410 transmits the package ID as the identification information of the pickup package and the pickup request to the management server 400 (S14 in FIG. 9 and S204 in FIG. 11). The pickup request includes information of the pickup location. The management server 400 may acquire information of the pickup location from the delivery server 410 using the package ID.

In a case where a pickup request is received (S101 in FIG. 10), the management server 400 generates an operate instruction of the moving body 100 based on the information of the pickup location (S15 in FIG. 9). For example, the management server 400 determines the moving body 100 of which the current location is closest to the pickup location, among the moving bodies 100 of which mobile services are “not in service” in the moving body management information table shown in FIG. 4, as the moving body 100 to be used for pickup (S16 in FIG. 9 and S102 in FIG. 10). Without being limited to the pickup location of the pickup package, the management server 400 may determine the moving body 100 based on information of the delivery destination of the pickup package, delivery destinations of other packages loaded into the moving body 100, a loading amount, and the like.

In a case where the moving body 100 to be used for pickup is determined, the management server 400 stores the package ID of the pickup package and the moving body ID, which is the identification information of the determined moving body 100, in the vehicle allocation information table shown in FIG. 7 so that the package ID of the pickup package and the moving body ID are associated with each other. In this case, the management server 400 also stores delivery areas specified by, for example, zip codes or municipalities, as information of the delivery destination of each pickup package, in the vehicle allocation information table. The delivery areas correspond to “delivery destinations of pickup packages”, and are used in loading pickup packages in the moving body 100 so as to be sorted.

The management server 400 transmits a pickup instruction to the moving body 100 determined in S16 together with the operate instruction generated in S15 (S17 in FIG. 9 and S103 in FIG. 10). In a case where the pickup instruction is received (S401 in FIG. 13), the moving body 100 generates an operate plan of the moving body 100 based on the operate instruction from the management server 400 (S18 in FIG. 9 and S402 in FIG. 13). The moving body 100 starts moving to the pickup location according to the generated operate plan (S19 in FIG. 9 and S403 in FIG. 13).

In a case where the moving body 100 arrives at the pickup location, the moving body 100 sends a request for information of the delivery destination (delivery area) of the pickup package to the management server 400 using the package ID (S20 in FIG. 9 and S404 in FIG. 13). In a case where the request for information of the delivery destination is received from the moving body 100 (S104 in FIG. 10), the management server 400 transmits the information of the delivery area to the moving body 100 (S21 in FIG. 9 and S105 in FIG. 10).

The information of the delivery area transmitted from the management server 400 to the moving body 100 is set as follows, for example. The management server 400 requests the delivery server 410 to send the delivery information of the pickup package using the package ID. In a case where the request for delivery information is received from the management server 400 (S205 in FIG. 11), the delivery server 410 transmits to the management server 400 the delivery information such as the delivery destination zip code and the delivery address stored in the delivery information table shown in FIG. 8 (S206 in FIG. 11). The management server 400 can set the delivery area based on the delivery destination zip code or the delivery address included in the delivery information. The management server 400 may also receive the delivery information of the pickup package in S14 in FIG. 9, store the delivery information of the pickup package in the moving body management DB 403 so as to be associated with the package ID, and set the delivery area based on the delivery information stored in the moving body management DB 403.

In a case where the information of the delivery area is received (S405 in FIG. 13), the moving body 100 sends a request for information of a loading place to the management server 400 (S22 in FIG. 9 and S406 in FIG. 13). The information of the loading place is, for example, information of association between a moving body section (hereinafter, also referred to as a “section”) and a delivery area shown in the moving body section information table in FIG. 5. In a case where the request for information of the loading place is received (S106 in FIG. 10), the management server 400 determines whether or not there is a section in the moving body 100 associated with the delivery area of the pickup package (S107 in FIG. 10). In a case where there is a section associated with the delivery area of the pickup package (S107 in FIG. 10: Yes), the management server 400 transmits the information of the association between the section and the delivery area to the moving body 100 (S24 in FIG. 9 and S109 in FIG. 10). In a case where there is no section associated with the delivery area of the pickup package (S107: No), the management server 400 associates the delivery area of the pickup package with a section that is not associated with other delivery areas (S108 in FIG. 10). Then, the management server 400 transmits the information of the association between the section and the delivery area to the moving body 100 (S24 in FIG. 9 and S109 in FIG. 10). In S24 in FIG. 9 (S109 in FIG. 10), the information of the association between the section and the delivery area may include at least information regarding which section is associated with the delivery area of the pickup package for which a pickup request has been made.

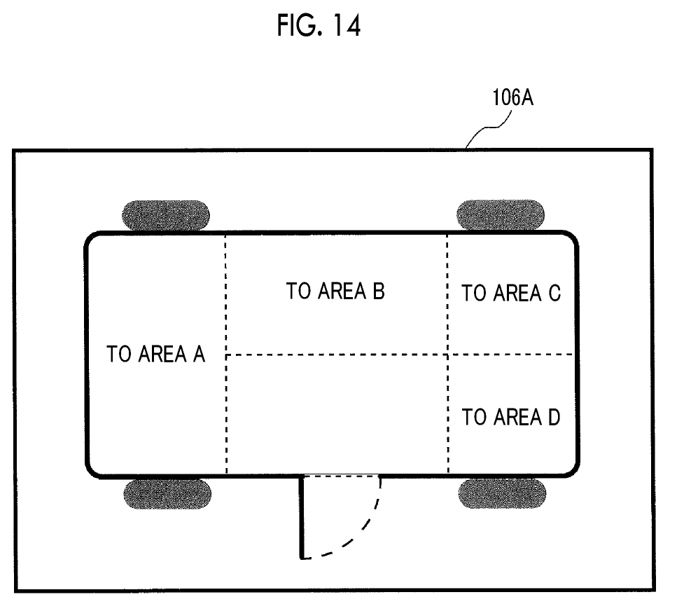

In order to support sorting of packages, the moving body 100 can display, for example, a sketch in the moving body 100, which shows the association between the section and the delivery area, on the display 106A based on the information of the loading place received from the management server 400. FIG. 14 is a display example of a display for supporting sorting of packages. The display 106A illustrated in FIG. 14 displays a sketch in a plan view of the inside of the moving body 100 from the upper surface side. The user who has made a pickup request can view the display of the display 106A and dispose the pickup package in a section associated with the delivery area. That is, in this specification, “control loading” may include providing information to a worker who disposes pickup packages in the moving body 100 so that each pickup package can be disposed in a section associated with the delivery area.

In a case where the loading of the pickup package into the moving body 100 is completed, the moving body 100 transmits to the user terminal 60 a notification that the pickup has been completed (S26 in FIG. 9, S304 in FIG. 12, and S409 in FIG. 13). In a case where the pickup is completed, the moving body 100 waits for the next pickup instruction (S409 in FIG. 13). The moving body 100 may start to move toward the delivery destination of the stored package according to the instruction from the management server 400.

Operation Effects of First Embodiment

In the first embodiment, in a case where a package pickup request is received, the moving body 100 acquires information of the delivery destination of the pickup package, and performs control so that the pickup package is loaded so as to be sorted according to the delivery destination of the pickup package in a case where the pickup package is loaded in the moving body 100. Since packages are loaded so as to be sorted for each delivery destination, it becomes easy to find a package to be delivered, among the packages loaded in the moving body, at the time of delivering the pickup package to the recipient. Therefore, it is possible to improve the efficiency of the package delivery work.

The moving body 100 may have the display 106A on the wall surface so that the information of the loading place for each delivery destination in the moving body is displayed on the display 106A. The user can dispose packages to be loaded in the moving body so as to be sorted for each delivery destination with reference to the information displayed on the display 106A.

### Second Embodiment

In the first embodiment, the moving body 100 presents the user with the information of the loading place for each delivery destination (delivery area) in the moving body 100, so that the user can load packages so as to be sorted for each delivery destination. On the other hand, in a second embodiment, instead of presenting the information of the loading place to the user, the moving body 100 transports the pickup package from the pickup location into the moving body 100 using the moving body for loading 110 provided in the moving body 100, and disposes the pickup package at the loading place so as to be sorted for each delivery destination.

Processing in the second embodiment different from the first embodiment will be described. In the second embodiment, instead of the processing (S25) for displaying the information of the loading place in the operation example of FIG. 9, the moving body 100 causes the moving body for loading 110 to collect pickup packages, transport the pickup packages into the moving body 100, and dispose each of the pickup packages at the loading place corresponding to the delivery destination.

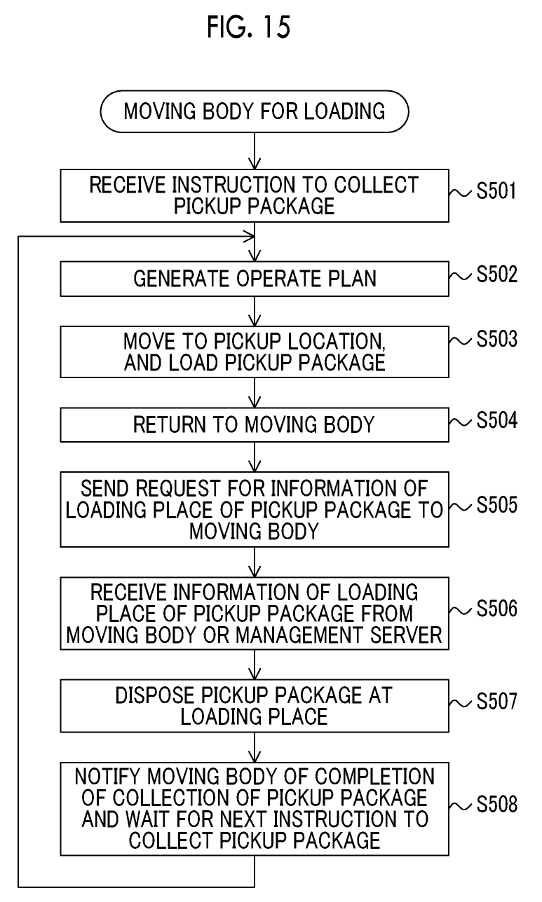

FIG. 15 is a flowchart showing a processing example of a controller of the moving body for loading in the second embodiment. The flow of the process starts, for example, in a case where the moving body 100 arrives at a pickup location where a pickup package is to be received and instructs the moving body for loading 110 to collect the pickup package.

First, in S501, the controller 113 of the moving body for loading 110 receives an instruction to collect a pickup package from the moving body 100 through the communication unit 115. In S502, the operate plan generator 1131 of the moving body for loading 110 generates an operate plan of the moving body for loading 110 based on the pickup location where the pickup package is to be received and the current location of the moving body 100. The operate plan includes a plan for a route from the current location of the moving body 100 to the pickup location and a return route from the pickup location to the current location of the moving body 100.

In S503, the travel controller 1133 of the moving body for loading 110 moves the moving body for loading 110 to the pickup location. The controller 113 loads the pickup package onto the moving body for loading 110. The pickup package may be loaded onto the moving body for loading 110 by the user who has made a request for pickup. In a case where the pickup package is loaded, the travel controller 1133 of the moving body for loading 110 returns the moving body for loading 110 to the moving body 100.

In S505, the controller 113 of the moving body for loading 110 sends a request for information of the loading place of the pickup package to the moving body 100. The information of the loading place of the pickup package is, for example, information of association between each section in the moving body 100 and a delivery area described with reference to FIG. 5. The moving body 100 can acquire the information of the loading place of the pickup package from the management server 400 and transmit the information of the loading place to the controller 113 of the moving body for loading 110. The controller 113 of the moving body for loading 110 may request the management server 400 to send the information of the loading place of the pickup package instead of sending the request to the moving body 100. In S506, the controller 113 receives the information of the loading place of the pickup package from the moving body 100 or the management server 400.

In S507, the controller 113 of the moving body for loading 110 disposes the pickup package at a loading place corresponding to the delivery destination (delivery area) based on the information of the loading place received in S506. In S508, the controller 113 of the moving body for loading 110 notifies the moving body 100 of the completion of the collection of the pickup package, and waits for the next instruction to collect a pickup package.

Operation Effects of Second Embodiment

In the second embodiment, the moving body 100 includes a moving body for loading for transporting a pickup package from the pickup location to the moving body 100. The moving body for loading is a robot or a small moving body that can move between the package pickup location and the moving body or within the moving body according to an instruction from the moving body 100. Using the moving body for loading 110, the moving body 100 can collect a pickup package, transport the pickup package into the moving body 100, and dispose the pickup package at a loading place corresponding to the delivery destination without manual operation. Therefore, it is possible to reduce manual work, such as collection of pickup packages and sorting of packages.

Recording Medium

A program for realizing any one of the functions described above in a computer or other machines and apparatuses (hereinafter, also referred to as “computer or the like”) can be recorded in a recording medium readable by a computer or the like. By causing a computer or the like to read and execute the program of the recording medium, the functions described above can be provided.

Here, the recording medium readable by a computer or the like refers to a non-transitory recording medium in which information, such as data or programs, is stored by electrical, magnetic, optical, mechanical, or chemical action and from which the information can be read by a computer or the like. Among such recording media, examples of recording media that can be detached from a computer or the like include a flexible disk, a magneto-optical disc, a compact disc read only memory (CD-ROM), a compact disc-rewritable (CD-R/W), a DVD, a Blu-ray disc, a digital audio tape (DAT), an 8-mm tape, and a memory card such as a flash memory. Examples of recording media fixed to a computer or the like include a hard disk and a ROM. A solid state drive (SSD) can be used as both a recording medium detachable from a computer or the like and a recording medium fixed to a computer or the like.

What is claimed is:

1. A moving body comprising:
a receiving unit configured to receive a request to pick up a pickup package from a user together with identification information of the pickup package;
a delivery information acquisition unit configured to acquire information of a delivery destination of the pickup package associated with the identification information of the pickup package; and
a loading control unit configured to control loading of the pickup package such that the pickup package is loaded at a loading place in the moving body corresponding to the delivery destination of the pickup package.

2. The moving body according to claim 1, further comprising
a display unit provided on a wall surface of the moving body, wherein the loading control unit is configured to display, on the display unit, information indicating the loading place for each delivery destination in the moving body.

3. The moving body according to claim 1, further comprising
a movable body for loading configured to load the pickup package into the moving body, wherein
the loading control unit is configured to cause the movable body for loading to dispose the pickup package at the loading place corresponding to the delivery destination of the pickup package.

4. A package sorting support method executed by a moving body, the package sorting support method comprising:
receiving a request to pick up a pickup package from a user together with identification information of the pickup package;
acquiring information of a delivery destination of the pickup package associated with the identification information of the pickup package; and
controlling loading of the pickup package such that the pickup package is loaded at a loading place in the moving body corresponding to the delivery destination of the pickup package.

5. A non-transitory storage medium storing a program, the program being executable by a computer of a moving body usable to load and deliver a pickup package picked up from a user, the program causing, when the program is executed by the computer, the computer to execute operations including
receiving a request to pick up the pickup package from the user together with identification information of the pickup package,
acquiring information of a delivery destination of the pickup package associated with the identification information of the pickup package, and
controlling loading of the pickup package such that the pickup package is loaded at a loading place in the moving body corresponding to the delivery destination of the pickup package.

6. A package sorting support system comprising:
a moving body; and
a management apparatus of the moving body, wherein:
the management apparatus includes a notification unit configured to
acquire delivery information including identification information of a pickup package and information of a delivery destination, and
notify the moving body of a request to pick up the pickup package, which is received from a user, together with the identification information of the pickup package; and
the moving body includes
a receiving unit configured to receive the request to pick up the pickup package from the user, which is sent through the management apparatus, together with the identification information of the pickup package,
a delivery information acquisition unit configured to acquire information of the delivery destination of the pickup package associated with the identification information of the pickup package, and
a loading control unit configured to control loading of the pickup package such that the pickup package is loaded at a loading place in the moving body corresponding to the delivery destination of the pickup package.
